(19) United States
(12) Patent Application Publication
(10) Pub. No.: US 2025/0001791 A1
(43) Pub. Date: Jan. 2, 2025

(54) COATING FOR A BLANKET CYLINDER OF A PRINTING MACHINE

(71) Applicant: Roberto LEVI ACOBAS, Milano (IT)

(72) Inventor: Roberto LEVI ACOBAS, Milano (IT)

(21) Appl. No.: 18/709,014

(22) PCT Filed: Nov. 12, 2021
(86) PCT No.: PCT/IT2021/000051

§ 371 Date: May 9, 2024

(51) Int. Cl. B41N 10/04; B41F 13/193; B41F 30/04

(52) U.S. Cl. CPC B41N 10/04; B41F 13/193; B41F 30/04; B41N 2210/06

(57) ABSTRACT

A coating for a blanket cylinder of a printing machine, having a multilayer structure comprising a blanket layer and an elastomeric layer having a first face solidly connected to said blanket layer, and a second face that goes into contact with said cylinder, wherein the blanket layer comprises at least one printing sublayer made of polymeric material and at least one fabric sublayer the elastomeric layer having a tensile stress, at 100% elongation according to standard ASTM D-412, comprised between 4.3 MPa and 1 MPa.

### CROSS-REFERENCE TO RELATED APPLICATION

The present application is a U.S. National Phase Application under 35 U.S.C. § 371 of International PCT/IT2021/000051 filed Nov. 12, 2021. The entire contents of which are hereby incorporated by reference.

### FIELD OF THE INVENTION

The present invention relates to a coating for a blanket cylinder of printing machines, particularly, but not exclusively, of the web offset or sheet-fed type. As is known to the persons skilled in the art, in these printing machines, a coating sheet having a base layer of rubberized material-called simply “blanket” in the industry or printing blanket (the term blanket will be used hereinafter)—is mounted on the printing cylinder, made of metal and rotatable about its own axis, and covers the lateral surface of the cylinder.

### BACKGROUND

The blanket layer is provided, on the two opposite sides thereof, with a respective metal bar, normally made of aluminium or steel, and having a U-shaped cross section so that it can be fitted onto the corresponding edge of the blanket and then fixed thereto. The two metal bars serve to fix the blanket to the aforesaid cylinder. Traditionally, the blanket layer comprises at least two sublayers, a fabric one and a rubber one, though blanket layers of a more complex structure, also comprising more than one fabric sublayer and more than one rubber sublayer, have since been produced. The fabric is for example cotton or PES fabric and even made of metal (in particular aluminium and steel alloys), whereas the rubber is for example of the nitrile/butyl type.

For every model of offset printing machine the manufacturer indicates the overall thickness of the coating that covers the blanket cylinder. The overall thickness of this coating is obtained also by using an undercoating (forming the so-called underblanket) in addition to the above-mentioned blanket layer (the actual coating).

The underblanket often consists of a sheet of cardboard or polyester that must be fixed to the blanket cylinder by means of an adhesive.

Sheet-fed machines usually use cardboard underblankets applied by means of fastening bars. Web offset machines use a sheet of polyester, which must be fixed onto the blanket cylinder by means of an adhesive.

In order to avoid the inconvenience tied to the complexity of the operations necessary to remove and replace the coating, a layer of elastomeric material has been proposed as an underblanket; it has a self-levelling capacity and a thickness such that, combined with the thickness of said blanket layer, it allows the desired overall thickness of the coating to be maintained.

The layer of elastomeric material of the type described above has a direct adhesion capacity without requiring the interposition of additional adhesive products for adhesion with the blanket cylinder, with a degree of adherence under static and dynamic conditions of said cylinder at least sufficient to ensure the maintenance of a perfect adhesion to the blanket cylinder on the one hand and an easy removal therefrom on the other.

However, it has been found that with an underblanket made of an elastomeric material of the known type, the coating, especially in the case of web offset printing machines, may progressively be subject to a loss of tensioning on the blanket cylinder.

The loss of tensioning manifests itself with losses of print registration and a consequent impairment of the print quality.

In order to return to an optimal print setting it is necessary to stop the printing process and adjust the tension of the coating prior to restarting. As may be easily imagined, in such a case one loses all of the advantages in terms of productivity.

It has also been observed that with an underblanket made of an elastomeric material of the known type, tensions may be generated which are concentrated in the area of the gap of the blanket cylinder where the coating, following the profile of the blanket cylinder, forms a sharp angle.

These tensions in turn may cause a further resistance to tensioning of the blanket, with a consequent loss in performance.

### SUMMARY

The task of the present invention is thus to provide a coating for a blanket cylinder of a printing machine that allows the aforementioned technical drawbacks of the prior art to be eliminated.

In particular, one object of the present invention is to provide a coating for a blanket cylinder of a printing machine that assures the perfect adhesion to the blanket cylinder without complicating the removal and replacement operations.

Another object of the present invention is to provide a long-lasting coating for a blanket cylinder of a printing machine.

These objects are achieved by a coating for a blanket cylinder of a printing machine, having a multilayer structure comprising a blanket layer and an elastomeric layer having a first face solidly connected to said blanket layer, and a second face adhering to said cylinder, wherein said blanket layer comprises at least one polymer printing sublayer and at least one fabric sublayer, characterized in that said elastomeric layer has a tensile stress, at 100% elongation according to standard ASTM D-412, comprised between 4.3 MPa and 1 MPa.

In one embodiment, said at least one printing sublayer is made of cross-linked elastomeric polymer.

In one embodiment, said multilayer structure comprises at least one compressible sublayer made of expanded cross-linked elastomeric polymer.

Said elastomeric layer has a hardness, according to standard ASTM D-2240 (ISO 868), comprised between 70 Shore A and 45 Shore A.

Preferably, said elastomeric layer is made of a material at least comprising a thermoplastic polyurethane.

The elastomeric layer maintains a self-levelling capacity and thickness such that, combined with the thickness of said blanket layer, it enables the desired overall thickness of the coating to be maintained.

The elastomeric layer further has an improved capacity to adhere directly to the blanket cylinder, without the need to interpose additional adhesive products. The properties of the elastomeric layer ensure, under static and dynamic conditions, both the maintenance of a perfect adhesion of the coating to the blanket cylinder and an easy removal thereof.

The coating is perfectly capable of maintaining the correct tensioning on the blanket cylinder and thus ensures proper print registration and consequently print quality.

Given that the printing process undergoes only a few brief interruptions, the productivity of the printing machine improves.

In practical terms, thanks to the characteristics of the elastomeric layer, the elastic return forces which may contribute to the aforementioned losses of tensioning of coatings of the known type are reduced.

Furthermore, thanks to the characteristics of the elastomeric layer, the loss of adherence of the coating in the area of the gap of the blanket cylinder is obviated. Furthermore, the elastomeric layer considerably reduces infiltrations of cleaning solutions in the sheets of the blanket. The infiltration of the cleaning solvents may lead over time to a separation of the layers making up the coating, lateral swelling, with a consequent loss of print registration, and damage to the support sheet, with a consequent structural failure.

By virtue of the intimate adhesion between the elastomeric layer and the surface of the blanket cylinder, the latter has a protective function against corrosion of the cylinder.

The elastomer layer is applied to the inner face of the blanket layer by means of a process of a known type in order to obtain the thickness prescribed by the machine manufacturer and in any case the thickness desired by the user (who may thus have a coating of a thickness tailored to his or her specific needs). The process of bonding the elastomer layer to the blanket layer may be of a mechanical, physical and/or chemical type, for example by means of a flat head extrusion process, calandering, spreading or another process.

The elastomer layer can be produced and simultaneously applied to the blanket layer or else it can be produced and subsequently bonded to the blanket layer.

It was possible to verify that with thicknesses of the aforesaid elastomer layer comprised between 0.05 mm and 1.50 mm it is possible in practice to cover all market demands.

Preferably, for the coating in accordance with the present invention the blanket layer has the following physicochemical properties, according to standard ASTM D 1894: static coefficient of friction μₛ>0.1: dynamic coefficient of friction μₖ>0.1.

These properties refer to the elastomer/steel surface. The invention will be more easily understood from the following description of an example embodiment thereof.

Further characteristics and advantages of the invention will become apparent from the description of a preferred, but not exclusive, embodiment of the apparatus of the coating for a blanket according to the invention, which is illustrated by way of non-limiting example in the attached drawings, of which:

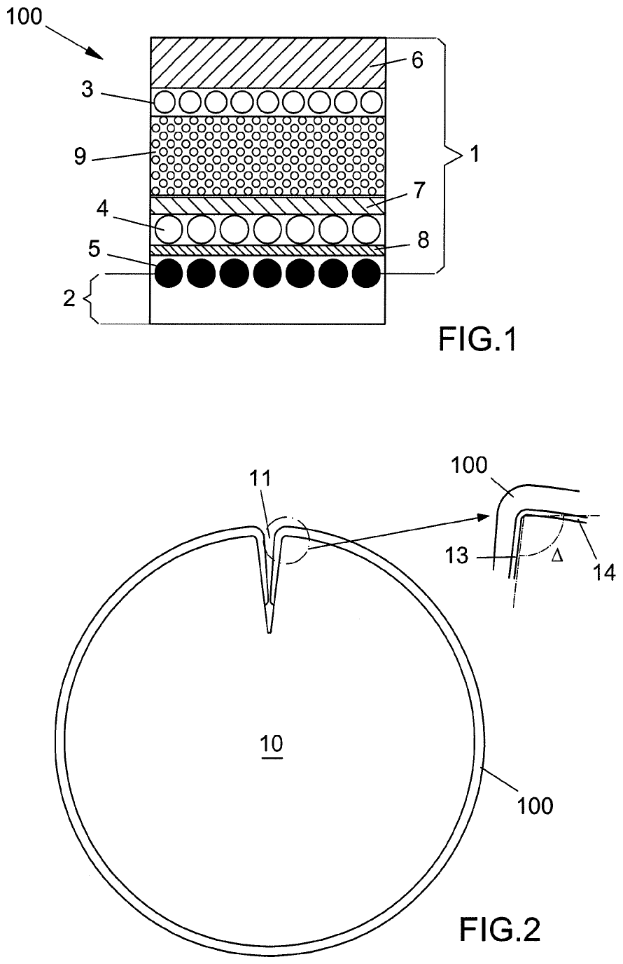

FIG. 1 schematically shows the cross section of a portion of a coating according to the invention; and

FIG. 2 shows the coating applied on the blanket cylinder.

### DETAILED-DESCRIPTION

As may be seen from the figure, the coating 100 comprises a conventional blanket layer 1, and an elastomer layer 2 applied to the inner face (the one turned towards the blanket cylinder 10) of the blanket layer 1. In the specific case illustrated, the blanket layer 1 is composed of a series of sublayers.

The blanket layer 1 comprises in particular at least one polymeric printing sublayer 6 and at least one fabric sublayer 3, 4, 5.

In one embodiment, the polymeric printing sublayer 6 is made of a cross-linked elastomeric polymer.

Furthermore, the multilayer structure may comprise at least one compressible sublayer made of an expanded cross-linked elastomeric polymer 9.

In the case illustrated, the blanket layer 1 comprises three cotton fiber-based fabrics 3, 4, 5 (but, as already mentioned, they could also be made of PES fiber or carbon fiber or a metal substrate), the outer printing sublayer 6 (constituting the face of the blanket layer opposite the surface of the blanket cylinder 10) formed from conventional nitrile/butyl rubber, one or more intermediate sublayers 7, 8 of rubber with a known and variable formulation and a compressible sublayer 9 made of expanded closed-cell cross-linked elastomeric polymer formed from nitrile/butyl rubber modified with the addition of an expanding agent.

The composition and structure of the blanket layer 1 may obviously differ from the one just described, also depending on the type of printing machine.

Supposing that one uses a Roland Colorman or a Uniman machine for newspapers, or a Lithoman machine for commercial printing, or a Heidelberg Speedmaster 102 sheet-fed printing machine, according to the printing machine model the thickness of the blanket layer 1 will be from 1.70 to 1.95 mm.

In particular, for a 48-page Lithoman machine using a 1.70 mm Vulcan Alto model blanket layer 1, and a 2 to 0.20 mm elastomer layer 2 having the above-mentioned characteristics, one obtains a coating having a total thickness of 1.90 mm.

Advantageously, the elastomeric layer 2 has a tensile stress, at 100% of elongation according to standard ASTM D-412 (ISO 527), comprised between 4.3 MPa and 1 MPa.

Preferably, the elastomeric layer 2 has a tensile stress, at 100% of elongation according to standard ASTM D-412 (ISO 527), comprised between 2.5 MPa and 1 MPa.

Furthermore, the elastomeric layer 2 has a hardness, according to standard ASTM D-2240, comprised between 70 Shore A and 45 Shore A.

Preferably, the elastomeric layer 2 has a hardness, according to standard ASTM D-2240, comprised between 60 Shore A and 45 Shore A.

The elastomeric layer 2 is made of a material at least comprising a thermoplastic polyurethane.

Preferably, the elastomeric layer 2 is made of a material at least comprising an aromatic polyester-based thermoplastic polyurethane. In particular, the use of a caprolactone modified thermoplastic polyurethane has been found to be advantageous.

The material of the elastomeric layer 2 can advantageously have silicone added to it to improve abrasion resistance and workability, in particular the material's suitability for extrusion.

The material of the elastomeric layer 2 is free of plasticizers, thus reducing the risk of degradation of the product over time.

The elastomeric layer 2 further has thermoplastic elastomers added to it, present in an amount comprised between 1% and 15% by weight.

Preferably, the thermoplastic elastomers added to the elastomeric layer 2 are present in an amount comprised between 8% and 12% by weight.

Said additives improve the production process and decrease the surface friction, thereby improving the slidability of the coating over the surface of the blanket cylinder.

As mentioned, the elastomeric layer 2 has a thickness comprised between 0.05 and 1.50 mm, with a tolerance of +/−0.01 mm.

According to the invention, the elastic return forces of the coating have been limited through a specific characterization of the elastomeric layer 2 defined by an original choice of the elastic elongation and, secondarily, hardness values thereof. By way of example, tensile tests were carried out on two reference samples consisting of a same blanket layer and a different elastomeric layer.

The reference blanket layer is 1.95±0.02 mm thick. The reference blanket layer is produced by Trelleborg and called Rollin Metro.

The elastomeric layer of the first reference sample has a tensile stress, at 100% of elongation according to standard ASTM D-412 (ISO 527), comprised between 4.3 MPa and 1 MPa. Said elastomeric layer has a hardness, according to standard ASTM D-2240 (ISO 868), comprised between 70 Shore A and 45 Shore A.

The elastomeric layer of the second reference sample has a tensile stress at 100% of elongation, according to standard ASTM D-412 (ISO 527), greater than 4.3 MPa. Said elastomeric layer has a hardness, according to standard ASTM D-2240 (ISO 868), greater than 70 Shore A.

The tests were performed at room temperature (23° C.) with the reference sample having a length of 10.0±0.1 cm, a width of 2.5±0.1 cm and a thickness of 2.80±0.05 mm.

The long side parallel to the direction of positioning of the coating on the blanket cylinder was selected.

The following results were obtained (average values for three tests) expressed as % of elongation under a given stress:

| # | A | B | C | D |
|---|---|---|---|---|
| Stress (N) | 113 | 226 | 544 | −1600 |
| Elongation of first | 1.66% | 2.04% | 2.93% | 6.64% |
| reference sample | | | | |
| Elongation of second | 1.61% | 1.91% | 2.60% | 5.30% |
| reference sample | | | | |

The results of the instrumental tests show that the first reference sample has a greater elongation than the second.

It was found that the deformability of the elastomeric layer 2 influences the tensions generated in the gap area 11 of the blanket cylinder 10, i.e., the area where the coating 100 is mechanically fixed to the blanket cylinder 10.

It was found to be convenient to select an elastomeric layer 2 having a hardness comprised between 70 and 45 Shore A, preferably between 60 and 45 Shore A, measured according to standard ASTM D-2240, in order to considerably reduce tensions in the gap area described.

The coating 100, once fixed to the inside of the gap area 11, is capable of following the surface of the blanket cylinder 10 for the entire circumference thereof.

In particular, at the exit 12 of the gap area 11, where a sharp angle A is created between the recessed surface 13 of the blanket cylinder 10 and the cylindrical surface 14 of the blanket cylinder 10, the coating 100 is capable of following the profile of the surface 13, 14 of the blanket cylinder 10.

The characteristic deformability and low hardness of the elastomeric layer 2 improve the adherence of the coating to the blanket cylinder 10.

The increase in adherence prevents the penetration of cleaning products between the coating and the blanket cylinder 10, thus improving the protection against aggressive chemical agents.

The elastomer layer 2 still has a self-levelling capacity and thickness such that, combined with the thickness of the blanket layer 1, it allows the desired overall thickness of the multilayer structure to be maintained. The second face of the elastomer layer 2 still has a direct adhesion capacity without requiring the interposition of additional adhesive products for adhesion with the blanket cylinder, with a degree of adherence under static and dynamic conditions of said cylinder at least sufficient to ensure the maintenance of a perfect adhesion to the blanket cylinder on the one hand and an easy removal therefrom on the other. Moreover, thanks to the special characteristics of the elastomeric layer 2, the coating 100 also has an ability to precisely copy the surface 13, 14 of the blanket cylinder 10 even where the sharp angle A is present.

The coating for printing machines thus conceived is susceptible of numerous modifications and variants, all falling within the scope of the inventive concept: moreover, all the details may be replaced by technically equivalent elements. The materials used, as well as the dimensions, may in practice be any whatsoever, according to needs and the state of the art.

1. A coating for a blanket cylinder of a printing machine, having a multilayer structure comprising a blanket layer and an elastomeric layer having a first face solidly connected to said blanket layer and a second face adhering to said cylinder, wherein said blanket layer comprises at least one printing sublayer made of polymeric material and at least one fabric sublayer, wherein said elastomeric layer has a tensile stress, at 100% of elongation according to standard ASTM D-412 (ISO 527), between 4.3 MPa and 1 MPa.

2. The coating for a blanket cylinder of a printing machine according to claim 1, wherein said elastomeric layer has a tensile stress, at 100% of elongation according to standard ASTM D-412 (ISO 527), between 2.5 MPa and 1 MPa.

3. The coating for a blanket cylinder of a printing machine according to claim 1, wherein said elastomeric layer has a hardness, according to standard ASTM D-2240, between 70 Shore A and 45 Shore A.

4. The coating for a blanket cylinder of a printing machine according to claim 3, wherein said elastomeric layer has a hardness, according to the standard ASTM D-2240, between 60 Shore A and 45 Shore A.

5. The coating for a blanket cylinder of a printing machine according to claim 1, wherein that said elastomeric layer is made of material comprising silicone, but free of plasticizers.

6. The coating for a blanket cylinder of a printing machine according to claim 1, wherein said elastomeric layer is made of a material comprising a thermoplastic polyurethane.

7. The coating for a blanket cylinder of a printing machine according to claim 6, wherein said elastomeric layer is made of a material comprising an aromatic polyester-based thermoplastic polyurethane.

8. The coating for a blanket cylinder of a printing machine according to claim 6, wherein said elastomeric layer is made of a material comprising additives including thermoplastic elastomers present in an amount between 1% and 15% by weight.

9. The coating for a blanket cylinder of a printing machine according to claim 8, wherein said thermoplastic elastomers are present in an amount between 8% and 12% by weight.

10. The coating for a blanket cylinder of a printing machine according to claim 1, wherein said elastomeric layer has a thickness between 0.05 and 1.50 mm, with a tolerance of +/−0.01 mm.

11. The coating for a blanket cylinder of a printing machine according to claim 1, wherein said elastomer layer has a self-levelling capacity and thickness such that, combined with the thickness of said blanket layer, it enables the desired overall thickness of said multilayer structure to be maintained.

12. The coating for a blanket cylinder of a printing machine according to claim 11, wherein said second face of said elastomer layer has a capacity of direct adhesion without requiring the interposition of additional adhesive products for adhesion with said blanket cylinder, with a degree of adherence under static and dynamic conditions at least sufficient to ensure the maintenance of a perfect adhesion to said blanket cylinder on the one hand and an easy removal therefrom on the other.

13. The coating for a blanket cylinder of a printing machine according to claim 1, wherein said elastomer layer has a capacity to follow the surface of said blanket cylinder at an exit of a gap area of said blanket cylinder where a sharp angle is created between a recessed surface of said blanket cylinder and a cylindrical surface of said blanket cylinder.
